(19) United States
(12) Patent Application Publication
(10) Pub. No.: US 2021/0102576 A1
(43) Pub. Date: Apr. 8, 2021

(54) SELF-ALIGNING ROLLER BEARING

(71) Applicant: Aktiebolaget SKF, Göteborg (SE)

(72) Inventors: Marcus Loof, Nol (SE); Alessio Nebbia Colomba, Pisa (IT)

(21) Appl. No.: 17/032,849

(22) Filed: Sep. 25, 2020

(30) Foreign Application Priority Data
Oct. 2, 2019 (IT) 102019000017690

(51) Int. Cl. F16C 23/08; F16C 19/28; F16C 33/46

(52) U.S. Cl. CPC F16C 23/082; F16C 33/4623; F16C 19/28

(57) ABSTRACT

The present disclosure relates to a self-aligning roller bearing comprising an inner bearing ring, an outer bearing ring and at least one row of roller elements interposed in-between the inner and the outer bearing ring. The roller bearing further comprises a cage comprising a ring-formed first cage portion and a plurality of distributed cage pocket bars protruding axially outwardly from an axial side face of the first cage portion, delimiting a plurality of cage pockets for the roller elements. The side face comprises one or more protrusions adapted to respectively abut a portion of an axial end face of a respective roller element, which portion comprises at least a radial centre of the roller element.

### CROSS REFERENCE TO RELATED APPLICATION

This application is based on and claims priority to Italian Application No. 102019000017690, filed Oct. 2, 2019, under 35 U.S.C. § 119 the entire contents of which are incorporated herein by reference.

### TECHNICAL FIELD

The present disclosure relates to a self-aligning roller bearing.

### BACKGROUND

Self-aligning roller bearings are known for their ability to handle demanding applications where the loads are high and where shaft deflections also can be expected. In fact, by using rollers instead of balls, larger loads can be accommodated. Moreover, the self-aligning capability, i.e., the capability of the bearing's inner and outer rings to be relatively misaligned, protects the bearing from internal stresses caused by shaft deflections, and therefore the bearing's service life is commonly not negatively affected by such deflections.

### BRIEF DESCRIPTION OF THE DRAWINGS

The various aspects of the non-limiting embodiments, including particular features and advantages, will be readily understood from the following detailed description and the accompanying drawings, in which:

FIG. 1 illustrates a schematic three-dimensional cross section view of an exemplifying self-aligning roller bearing according to embodiments of the disclosure; and

FIG. 2 illustrates a schematic view of the cage of FIG. 1.

### DETAILED DESCRIPTION

There are different types of self-aligning roller bearings. One type is the spherical roller bearing comprising two rows of symmetrical rollers, a common sphered outer ring raceway and two inner ring raceways inclined at an angle to the bearing axis, with the center point of the sphere in the outer ring raceway at the bearing axis. Another example of a self-aligning roller bearing is the commonly known spherical roller bearing having two rows of asymmetrical rollers, and yet another example the commonly known toroidal roller bearing comprising one row of rollers, where the bearing can accommodate both shaft deflections and axial shaft displacements.

A self-aligning roller bearing such as a spherical roller bearing commonly comprises one or two cages, e.g., of window type or prong type, for retaining roller elements interposed in-between the inner and outer bearing rings. Moreover, a self-aligning roller bearing commonly further comprises a guide ring, e.g., a floating guide ring, or a central fixed flange or rib, which may guide unloaded roller elements to enter a load zone in an optimal axial position. The e.g., floating guide ring—which may be centered either on the inner ring or on the cage or cages—may prevent the unloaded roller elements to move axially towards the center of the bearing, thus preventing the roller elements from being squeezed between the raceways when entering the load zone.

Friction between different components within self-aligning roller bearings during use of said bearings and/or the implementation of commonly known guide rings, flanges and/or ribs may, however, lead to component wear and further to noise such as rattling noise which may be undesirable for a wide range of applications, e.g., involving fans and/or elevators. Accordingly, there is room for improvement in known self-aligning roller bearings for at least these reasons.

Non-limiting embodiments of the present disclosure will now be described more fully hereinafter with reference to the accompanying drawings, in which currently preferred embodiments of the disclosure are shown. This disclosure may, however, be embodied in many different forms and should not be construed as limited to the embodiments set forth herein. Like reference characters refer to like elements throughout.

In the following, according to embodiments herein which relate to a self-aligning roller bearing, there will be disclosed an improved and/or alternative self-aligning roller bearing.

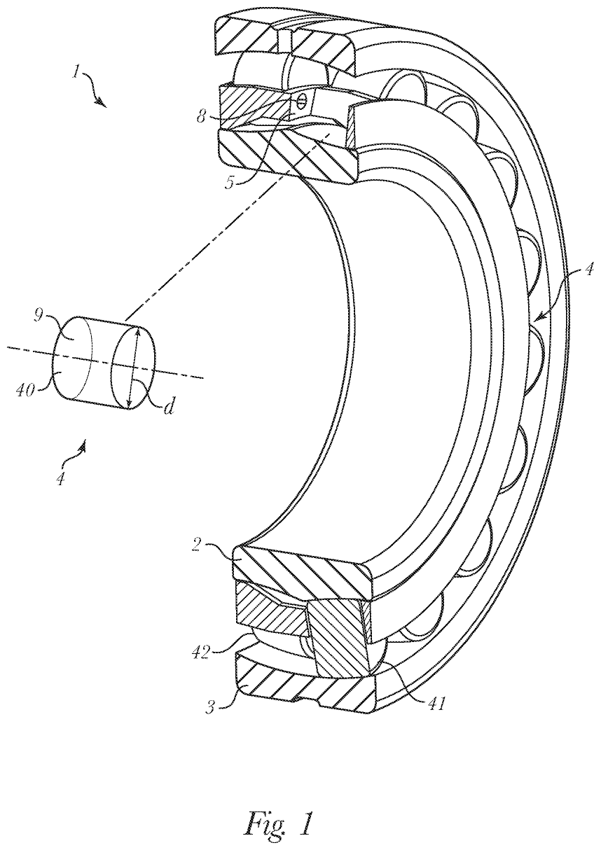

Referring now to the figures and FIG. 1 in particular, there is depicted a schematic cross section view of an exemplifying self-aligning roller bearing 1 according to embodiments of the disclosure.

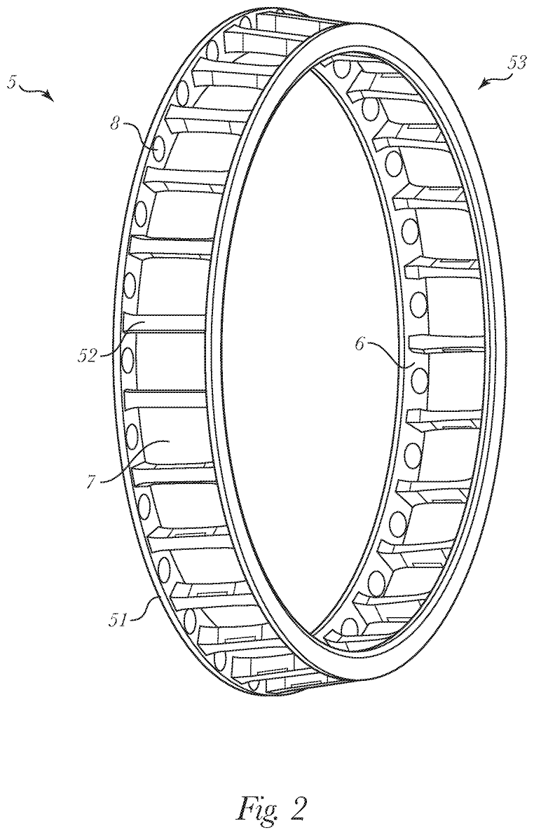

The self-aligning roller bearing 1 comprises an inner bearing ring 2, an outer bearing ring 3 and at least one row 41, 42 of roller elements 4 interposed in-between the inner and the outer bearing ring 2, 3. A roller bearing 1 further comprises a cage 5, which cage 5—as illustrated in FIG. 2—comprises a ring-formed first cage portion 51 and a plurality of distributed cage pocket bars 52 protruding axially outwardly from an axial side face 6 of the first cage portion 51, delimiting a plurality of cage pockets 7 for the roller elements 4.

Optionally, and as illustrated in exemplifying FIG. 2, the cage 5 may further comprise a ring-formed second cage portion 53 axially parallel with the first ring portion 51, which second cage portion 53 connects together end portions of the cage pocket bars 52 axially. Thereby, the second cage portion 53 contributes to the holding of the roller elements 4 inside the cage pockets 7, and further limits the axial movement of the roller elements 4 inside the cage pockets 7 towards the e.g., outside of the self-aligning roller bearing 1.

Further optionally, and as illustrated in exemplifying FIG. 1, the self-aligning roller bearing 1 may be a double row self-aligning roller bearing with two rows 41, 42 of roller elements 4, such as a spherical double-row bearing, without a guide ring, flange and/or rib.

Yet further optionally, the self-aligning roller bearing 1 may be adapted for rotating speeds higher than a threshold orbital speed at which the roller elements 4 are affected by centrifugal forces that exceeds the gravity forces.

The self-aligning roller bearing 1 may have any dimensions deemed feasible, for instance adapted for the application at hand. Moreover, the expression “roller bearing” may potentially refer to “spherical roller bearing” and/or “spherical double-row bearing”. The inner bearing ring 2—which may take on any dimensions deemed feasible—may be represented by any commonly known inner ring suited for a self-aligning roller bearing such as a spherical double-row bearing, and further comprise any known applicable material. The inner bearing ring 2 may thus, as shown in exemplifying FIG. 1, comprise—on its outer radial periphery—two axially adjacent raceways, each in the form of a truncated sphere, where roller elements 4 of the same row 41, 42 may roll on only one of the raceways of the inner ring 2. Correspondingly, the outer bearing ring 3—which may take on any dimensions deemed feasible—may be represented by any commonly known outer ring suited for a self-aligning roller bearing such as a spherical double-row bearing, and further comprise any known applicable material. The outer ring 2 may thus, as shown in exemplifying FIG. 1, comprise—on its inner radial periphery—a raceway in the form of a truncated sphere, where the roller elements 4 may roll. Both the inner bearing ring 2 and the outer bearing ring 3 may be rotatable around an axis of symmetry of the self-aligning roller bearing 1.

Herein, the word “axial” or “axially” may refer to a direction parallel to the axis of symmetry of the roller bearing 1, a roller element 4 and/or the cage 5, as applicable, whereas the word “radial” or “radially” may refer to a direction perpendicular to the axis of symmetry of the bearing 1, a roller element 4 and/or the cage 5, as applicable.

The roller elements 4—which may have any dimensions deemed feasible—may be represented by any commonly known rollers suited for a self-aligning roller bearing such as a spherical double-row bearing, and further comprise any known applicable material.

The roller elements 4 may for instance—as shown in exemplifying FIG. 1—be arranged in two axially adjacent rows 41, 42. The expression “roller elements” may refer to “rollers” and/or “rollers of essentially cylindrical shape”, whereas “roller elements” according to an example further may refer to “spherical roller elements”.

The cage 5, on the other hand, which similarly may have any dimensions deemed feasible, may be represented by any commonly known roller bearing cage suited for a self-aligning roller bearing such as a spherical double-row bearing, e.g., of window type or prong type, with the exception of the additional features discussed herein. The cage 5 may be inner ring guided, or alternatively e.g., outer ring guided or guided by the roller elements 4. The expression “cage” may refer to “roller bearing cage”, whereas the phrase “cage comprising” according to an example may refer to “cage for retaining and/or guiding said roller elements, said cage comprising”. Moreover, the expression “ring-formed” first/second cage portion may refer to “annular” and/or “circular” first/second cage portion, whereas cage “portion” may refer to cage “core”. “First cage portion” may according to an example refer to “inner cage portion” and/or “inner part”. “Distributed” cage pockets bars, on the other hand, may refer to “evenly distributed” cage pockets bars, whereas “protruding axially outwardly” may refer to “protruding essentially axially outwardly”. Moreover, the phrase “plurality of cage pockets for said roller elements” may refer to “plurality of evenly distributed cage pockets for said roller elements” and/or “plurality of cage pockets for said roller elements such that there is provided a respective cage pocket for each respective roller element of the at least one row of roller elements”.

According to the introduced concept, the side face 6 of the cage's 5 first cage portion 51 comprises one or more protrusions 8 adapted to respectively abut a region of an axial end face 9 of a respective roller element 4, which region comprises at least a radial centre 40 of the roller element 4. Thereby, at least a first protrusion 8 protruding from a side surface 6 of the cage 5 facing the roller elements 4, abuts an end 9—such as an inner end—of a roller element 4 at a contact area at and/or around a rotational axis of said roller element 4, at least during use of the bearing 1 and/or during roller element 4 axial displacement and/or roller element 4 skewing. Accordingly, the roller elements 4 come into contact with the side face 6 of the cage 5 via said protrusions 8 at the centres 40 of the roller elements 4, thus enabling for abutment with said roller elements 4 where their tangential velocity—during use of the bearing 1—is zero or essentially zero. Thus, sliding in contact with the roller elements 4—and subsequently component wear—may be avoided or at least kept at a minimum, potentially increasing component life.

Moreover, optionally, the one or more protrusions 8 and/or the first cage portion 51 may further be adapted for guiding the respective roller element 4 into correct axial position. Thereby, the protrusions 8 and/or the first cage portion 51 may prevent the roller elements 4 from moving axially towards the centre of the bearing 1, and accordingly, guiding of the roller elements 4 may be provided by means of the protrusions 8 and/or the first cage portion 51, thus eliminating or at least reducing a need for a guide ring, flange and/or rib commonly comprised in bearings such as spherical double-row bearings of the state of the art for guiding roller elements between the two roller rows. Consequently, the introduced roller bearing 1 may potentially be provided without a guide ring, flange and/or rib, thus enabling for weight and/or cost of a roller bearing and/or noise such as rattling noise during use of said roller bearing, to potentially be lowered.

For instance, the first cage portion 51 may be designed to drive respective roller element 4 back into correct axial position by including similarities of known guide ring, flange and/or rib geometry. For instance, a distance between the first cage portion 51 and the inner ring 2 may be adapted to match known guide ring, flange and/or rib solution in a manner such that the first cage portion 51 is the first part to touch the inner ring 2 thus acting as an inner ring centered roller guidance. The term “correct” axial position may refer to “optimal”, “desired” and/or “a predeterminable” axial position, whereas the expression “guiding the respective roller element into correct axial position” may refer to “guiding the respective roller element into correct axial position at least during use of the self-aligning roller bearing” and/or “guiding the respective roller element into correct axial position at least during roller element axial displacement and/or roller element skewing”.

Optionally, the one or more protrusions 8 may be distributed along the side face 6 such that a respective protrusion 8 is provided for each cage pocket 7.

A protrusion 8 may have any dimensions and or shapes deemed feasible to—at least during use of the bearing 1 and/or during roller element 4 axial displacement and/or roller element 4 skewing—abut with a region of the end face 9 of a roller element 4 which region comprises the radial centre 40 of the roller element 4. Similarly, said region of a roller element end face 9 may have any dimensions deemed feasible, and for instance range from less than a millimetre radius up to several hundreds of millimetres radius, and/or range from a radius of less than one percent of the roller element's 4 radius up to 50 percent of the roller element's 4 radius. In a similar manner, the end face 9 of a roller element 4—which is perpendicular to the rotational axis of the roller element 4—may take on any dimensions and or shapes deemed feasible. According to an example, the end faces 9 may be flat; alternatively, however, said end faces may be for instance domed, concave etc.

The expression side “face” may refer to side “surface”, whereas “side” face may refer to “outer” face. “Protrusions”, on the other hand, may according to an example refer to “bulges” and/or “bumps”, whereas “abut” may refer to “come into contact with”. The phrase “adapted to respectively abut” may according to an example refer to “adapted to at least during use of said self-aligning roller bearing respectively abut” and/or “adapted to at least during roller element axial displacement and/or roller element skewing respectively abut”. The expression “a region” of an axial end face may refer to “an area”, “a contact area” and/or “a portion” of an axial end face, whereas end “face” may refer to end “surface”. “Radial centre” of the roller element may refer to “radial essentially centre” of the roller element, and further to “axis” and/or “rotational axis” of the roller element.

Optionally, the one or more protrusions 8 may respectively have a shape free from edges.

Thereby, component wear may be limited in that no edges protrude from the first cage portion's 51 side face 6. Further optionally, the one or more protrusions 8 may respectively have a shape of a truncated sphere. The expression “edges” may refer to “sharp edges”, whereas “truncated sphere” may refer to “dome”.

Moreover optionally, the one or more protrusions 8 may respectively have a maximum extension in a normal direction exceeding at least 0.5% of a diameter d of the roller elements 4, preferably exceeding at least 1% of said roller diameter d. Thereby, the protrusion extension is large enough not to allow a bottom i.e., corners of a cage pocket 7 to interfere with the roller element end face 9. The expression “extension” may refer to “height”, whereas “normal direction” according to an example may refer to “axial direction”. “An axial length”, on the other hand, may refer to “a width”.

At least a portion of the cage 5 and/or the one or more protrusions 8 may be made from a metallic material such as steel, cast iron or brass. Optionally, however, at least a portion of the cage 5 and/or the one or more protrusions 8 may comprise a polymer material. Thereby, the protrusions 8 and/or the cage 5 as a whole or in part may comprise commonly utilized material for cages known in the art, such as e.g., PA66 and/or PEEK. Additionally or alternatively, at least a portion of the cage 5 and/or the one or more protrusions 8 may be made from synthetic material, and/or a composite material comprising polymer.

Optionally, the one or more protrusions 8 together with the first cage portion 51 and/or the cage 5 may form a single entity. Thereby, protrusions 8 may be integrated with at least the first cage portion 51 into a single piece, thus enabling for fewer components and/or less complexity.

It is therefore an object of embodiments herein to provide a self-aligning roller bearing that overcomes or ameliorates at least one of the disadvantages of the prior art, or to provide a useful alternative.

The object above may be achieved by the subject-matter disclosed herein. Embodiments are set forth in the appended claims, in the following description and in the drawings.

The disclosed subject-matter relates to a self-aligning roller bearing comprising an inner bearing ring, an outer bearing ring and at least one row of roller elements interposed in-between the inner and the outer bearing ring. The roller bearing further comprises a cage comprising a ring-formed first cage portion and a plurality of distributed cage pocket bars protruding axially outwardly from an axial side face of the first cage portion, delimiting a plurality of cage pockets for the roller elements. The side face comprises one or more protrusions adapted to respectively abut a portion of an axial end face of a respective roller element, which portion comprises at least a radial centre of the roller element.

Thereby, there is introduced an approach according to which at least a first protrusion protruding from a side surface of the cage facing the roller elements, abuts an end—such as an inner end—of a roller element at a contact area at and/or around a rotational axis of said roller element, at least during use of the bearing and/or during roller element axial displacement and/or roller element skewing. Accordingly, the roller elements come into contact with the side face of the cage via said protrusions at the centres of the roller elements, thus enabling for abutment with said roller elements where their tangential velocity—during use of the bearing—is zero or essentially zero. Thus, sliding in the contact with the roller elements—and subsequently component wear—may be avoided or at least kept at a minimum, potentially increasing component life.

Moreover, since the one or more protrusions and/or the first cage portion further optionally may be adapted for guiding the respective roller element into correct axial position, the protrusions and/or the first cage portion may prevent the roller elements from moving axially towards the centre of the bearing, and accordingly, guiding of the roller elements may be provided by means of the protrusions and/or the first cage portion, thus eliminating or at least reducing a need for a guide ring, flange and/or rib commonly comprised in bearings such as spherical double-row bearings of the state of the art for guiding roller elements between the two roller rows. Consequently, the introduced roller bearing may potentially be provided without a guide ring, flange and/or rib, thus enabling for weight and/or cost of a roller bearing and/or noise such as rattling noise during use of said roller bearing, to potentially be lowered.

For that reason, there is provided an improved and/or alternative self-aligning roller bearing.

The technical features and corresponding advantages of the above mentioned roller bearing will are discussed throughout this disclosure. The person skilled in the art realizes that the present disclosure by no means is limited to the preferred embodiments described above. On the contrary, many modifications and variations are possible within the scope of the appended claims. It should furthermore be noted that the drawings not necessarily are to scale and the dimensions of certain features may have been exaggerated for the sake of clarity. Emphasis is instead placed upon illustrating the principle of the embodiments herein. Additionally, in the claims, the word “comprising” does not exclude other elements or steps, and the indefinite article “a” or “an” does not exclude a plurality.

1. A self-aligning roller bearing, comprising:
an inner bearing ring;
an outer bearing ring;
at least one row of roller elements interposed in-between said inner and said outer bearing ring; and
a cage comprising a ring-formed first cage portion and a plurality of distributed cage pocket bars protruding axially outwardly from an axial side face of said first cage portion, delimiting a plurality of cage pockets for said roller elements,
wherein said side face comprises one or more protrusions adapted to respectively abut a region of an axial end face of a respective roller element, which region comprises at least a radial centre of said roller element.

2. The self-aligning roller bearing of claim 1, wherein said one or more protrusions and/or said first cage portion further are adapted for guiding said respective roller element into correct axial position.

3. The self-aligning roller bearing according of claim 1, wherein said one or more protrusions respectively has a shape free from edges, such as a shape of a truncated sphere.

4. The self-aligning roller bearing according of claim 2, wherein said one or more protrusions respectively has a shape free from edges, such as a shape of a truncated sphere.

5. The self-aligning roller bearing of claim 1, wherein said one or more protrusions respectively has a maximum extension in a normal direction exceeding at least 0.5% of a diameter (d) of said roller elements, preferably exceeding at least 1% of said roller diameter (d).

6. The self-aligning roller bearing of claim 4, wherein said one or more protrusions respectively has a maximum extension in a normal direction exceeding at least 0.5% of a diameter (d) of said roller elements, preferably exceeding at least 1% of said roller diameter (d).

7. The self-aligning roller bearing of claim 1, wherein at least a portion of said cage and/or said one or more protrusions comprise a polymer material.

8. The self-aligning roller bearing of claim 6, wherein at least a portion of said cage and/or said one or more protrusions comprise a polymer material.

9. The self-aligning roller bearing of claim 1, wherein said one or more protrusions together with the first cage portion and/or the cage form a single entity.

10. The self-aligning roller bearing of claim 8, wherein said one or more protrusions together with the first cage portion and/or the cage form a single entity.

11. The self-aligning roller bearing of claim 1, wherein said one or more protrusions are distributed along said side face such that a respective protrusion is provided for each cage pocket.

12. The self-aligning roller bearing of claim 10, wherein said one or more protrusions are distributed along said side face such that a respective protrusion is provided for each cage pocket.

13. The self-aligning roller bearing of claim 1, wherein said cage further comprises a ring-formed second cage portion axially parallel with said first ring portion, said second cage portion connecting together end portions of said cage pocket bars axially.

14. The self-aligning roller bearing of claim 12, wherein said cage further comprises a ring-formed second cage portion axially parallel with said first ring portion, said second cage portion connecting together end portions of said cage pocket bars axially.

15. The self-aligning roller bearing of claim 1, wherein said self-aligning roller bearing is adapted for rotating speeds higher than a threshold orbital speed at which said roller elements are affected by centrifugal forces that exceeds the gravity forces.

16. The self-aligning roller bearing of claim 14, wherein said self-aligning roller bearing is adapted for rotating speeds higher than a threshold orbital speed at which said roller elements are affected by centrifugal forces that exceeds the gravity forces.

17. The self-aligning roller bearing of claim 1, wherein said self-aligning roller bearing is a double row self-aligning roller bearing with two rows of roller elements, such as a spherical double-row bearing, without a guide ring, flange and/or rib.

18. The self-aligning roller bearing of claim 16, wherein said self-aligning roller bearing is a double row self-aligning roller bearing with two rows of roller elements, such as a spherical double-row bearing, without a guide ring, flange and/or rib.

19. A cage for a self-aligning roller bearing, comprising:
a ring-formed first cage portion and a plurality of distributed cage pocket bars protruding axially outwardly from an axial side face of said first cage portion, delimiting a plurality of cage pockets for said roller elements,
wherein said axial side face comprises one or more protrusions adapted to respectively abut a region of an axial end face of a respective roller element, which region comprises at least a radial centre of said roller element.

20. A cage for a self-aligning roller bearing, comprising:
a ring-formed first cage portion and a plurality of distributed cage pocket bars protruding axially outwardly from an axial side face of said first cage portion, delimiting a plurality of cage pockets for said roller elements,
wherein said axial side face comprises one or more protrusions adapted to respectively abut a region of an axial end face of a respective roller element, which region comprises at least a radial centre of said roller element, further wherein said one or more protrusions and/or said first cage portion further are adapted for guiding said respective roller element into correct axial position, further wherein said one or more protrusions respectively has a shape free from edges, such as a shape of a truncated sphere, wherein said one or more protrusions respectively has a maximum extension in a normal direction exceeding at least 0.5% of a diameter (d) of said roller elements, preferably exceeding at least 1% of said roller diameter (d).
